(19) United States
(12) Patent Application Publication
(10) Pub. No.: US 2026/0336590 A1
(43) Pub. Date: Oct. 29, 2026

(54) Method for Actuating a Brake System in a Vehicle

(71) Applicant: Robert Bosch GmbH, Stuttgart (DE)

(72) Inventors: Matthias Vieth, Besigheim (DE); Frank Baehrle-Miller, Schoenaich (DE); Gilles Dubos, Drancy (FR); Laurent Renault, Drancy (FR); Otmar Bussmann, Abstatt (DE); Tobias Putzer, Flein (DE)

(21) Appl. No.: 19/102,499

(22) PCT Filed: Jul. 14, 2023
(86) PCT No.: PCT/EP2023/069600

§ 371 Date: Feb. 10, 2025

(30) Foreign Application Priority Data
Aug. 24, 2022 (DE) 10 2022 208 761.5

(51) Int. Cl. B60T 13/74; B60T 13/14; B60T 17/22

(52) U.S. Cl. CPC B60T 13/746; B60T 13/143; B60T 17/221; B60T 2220/04; B60T 2270/10; B60T 2270/402; B60T 2270/403

(57) ABSTRACT

A method for actuating a brake system in a vehicle, in which the brake system has a hydraulic vehicle brake and an electromechanical braking device, includes actuating the electromechanical braking force when a brake servo unit of the hydraulic vehicle brake partially or entirely breaks down, with the electromechanical braking force being increased in multiple stages.

The invention relates to a method for actuating a brake system in a vehicle, in which the brake system has a hydraulic vehicle brake equipped with a brake servo unit and at least one electromechanical braking device with an electric braking motor to generate an electromechanical braking force.

### PRIOR ART

DE 10 2004 004 992 A1 discloses a parking brake system in a vehicle in which a clamping force, which keeps the vehicle at a standstill, is generated via an electric braking motor by means of the electric braking motor moving a brake piston against a brake disc. The parking brake system is integrated into the hydraulic vehicle brake. During regular braking operation, the brake piston is pressed against the brake disk by the hydraulic brake fluid.

DE 10 2018 210 021 discloses a method for operating a brake system of a motor vehicle equipped with a hydraulic braking device, an electromechanical braking device and a brake pedal. In the event of a fault in the hydraulic braking device, an electromechanical braking force is applied via the electromechanical braking device in order to stop motor vehicle.

DE 10 2018 208 877 A1 discloses a method for operating a motor vehicle brake system, which includes a hydraulic braking device, an electromechanical braking device, a brake pedal as a first actuating device and a button as a second actuating device. An electromechanical braking force is generated by the electromechanical braking device to slow the motor vehicle in the event of a fault in the hydraulic braking device, regardless of which of the two actuating devices is activated.

### DISCLOSURE OF THE INVENTION

The method according to the invention relates to a vehicle with a hydraulic vehicle brake via which, during regular braking operation, the vehicle is decelerated by applying hydraulic brake pressure to wheel brake devices of the hydraulic vehicle brake, thereby moving a brake piston in the wheel brake device against a brake disc.

The hydraulic vehicle brake also includes at least one brake servo unit for increasing the driver-generated braking pressure. The brake servo unit is preferably electrically actuatable, for example, using an electrically controllable actuator, which is advantageously located downstream of a master brake cylinder of the vehicle brake. For example, the electrically controllable actuator is a plunger powered by an electric motor. The plunger moves brake fluid into one or more brake circuits of the hydraulic vehicle brake and builds hydraulic brake pressure.

In principle, the brake servo unit may also be configured to be non-electrically actuatable, for example hydraulically actuatable.

In addition, at least a portion of the wheel braking devices of the hydraulic vehicle brake are each equipped with an electromechanical braking device with an electric brake motor, in particular the wheel braking devices on the left and right wheels of the rear axle of the vehicle. The electromechanical braking device with the electric brake motor may be actuated when parking the vehicle to generate a sustained parking braking force by electromechanical means. In the preferred embodiment, the electric brake motor of the electromechanical braking device acts on the same brake piston as the hydraulic vehicle brake.

In the method according to the invention for actuating the brake system, in the event of a partial failure or a complete failure of the brake servo unit of the hydraulic vehicle brake, the electromechanical braking device is actuated during braking in addition to the hydraulic braking force. This is done in such a way that the electromechanical braking force increases in several stages, with the electromechanical braking force being kept constant or approximately constant at each stage. Building up of the electromechanical braking force is thus carried out according to a stair function. It has been shown that this procedure significantly improves braking control. Deadtimes that may affect braking control are eliminated or at least reduced. The brake governors used for the hydraulic vehicle brake and the electromechanical braking device may also be reused in the event of failure or partial failure of the brake servo unit of the hydraulic vehicle brake.

According to one advantageous embodiment, a maximum electromechanical braking support is established, wherein the stages of the electromechanical braking force each correspond to a defined percentage of the maximum electromechanical braking support. For example, the maximum electromechanical braking support is a 4 m/s² delay. The value of the maximum electromechanical braking support may be determined depending on the vehicle and/or currently determined from the driving situation, for example as a function of the current driving state and operational variables such as the current vehicle speed or the loading of the vehicle, etc. The various stages that the electromechanical braking force goes through while building up may be different percentage values of the maximum electromechanical braking support, whereby equidistant distances between the stages and differently sized distances between the stages are both possible.

Different numbers of stages for building up the electromechanical braking force are possible. Preferably, at least three or at least four stages are specified, which is sufficient to achieve an improvement in braking control. If necessary, at least seven or at least ten stages are specified. It is possible to implement both a fixed number of stages and to variably set the number of stages, particularly as a function of current travel state and operational variables such as the current vehicle speed or the loading of the vehicle, etc.

The minimum duration for each stage to switch from one stage to the next is advantageously at least 20 ms, preferably at least 50 ms. This ensures that the stages can be adjusted in a targeted manner. The minimum duration may be fixed or variably set, particularly as a function of current travel state and operational variables such as the current vehicle speed or loading of the vehicle, etc.

The current duration of each individual stage may depend on the state or operational variables of the vehicle, for example, the electrical voltage in the on-board power system or the motor speed of the braking motor. Preferably, all stages have the same duration. Alternatively, it may also be expedient for different stages to have different durations.

According to a further advantageous embodiment, the maximum electromechanical braking support is set to a value less than the maximum possible mechanical braking force. This ensures that the maximum electromechanical braking support reaches, at most, a level at which locking of the wheels is avoided. The maximum electromechanical braking support represents an upper limit up to which a gradual building up of electromechanical braking force is possible.

According to another advantageous embodiment, the electromechanical braking force depends on the height of the brake pedal actuation, wherein, upon reaching a brake pedal actuation limit, the electromechanical braking force is limited to the maximum electromechanical braking force support. For example, the brake pedal actuation limit is defined as a defined pedal force with which the brake pedal is actuated, for example 200 N. Alternatively, a defined pedal travel distance may also be defined when actuating the brake pedal.

In another preferred embodiment, the electromechanical braking force is not generated until the hydraulic brake pressure in the hydraulic vehicle brake reaches or exceeds a minimum pressure, for example at five bars. Up to the minimum pressure, only the hydraulic vehicle brake is actuated, and only upon exceeding the minimum pressure is the electromechanical braking force generated. However, it is possible for the electric brake motor to already be actuated below the hydraulic minimum pressure without generating electromechanical braking force in order to reduce the clearance distance until the brake pads are applied to the brake disc. The clearance distance reduction may be linked to the additional condition that the hydraulic brake pressure is greater than zero or that the brake pedal travel distance is greater than zero.

Alternatively, it is also possible for the electric braking motor to remain unactuated below the hydraulic minimum pressure.

In principle, the braking control mechanisms may also be retained with simultaneous actuation of the hydraulic vehicle brake and electromechanical braking device. In the event of increased slipping on a vehicle wheel, it is expedient for the electromechanical braking force acting on such wheel to first be reduced and, only in the event that further braking force reduction is required, the hydraulically generated braking force is then also reduced.

According to a further advantageous embodiment, not only the increase, but also the reduction of the electromechanical braking force is carried out in several stages, for example when a braking process is ended or when the braking force is reduced. Even in the event of a reduction, progressive reduction of the electromechanical braking force with regard to braking force control is advantageous. However, it may be sufficient for the electromechanical braking force to be reduced in one stage without intermediate stages, in particular in cases where the driver fully stops brake pedal operation.

The invention also relates to a control device which comprises means that are configured to carry out the previously described method. The means include at least one memory unit, at least one computing unit, a control device input and a control device output. Using the control device, the adjustable components of the hydraulic vehicle brake and/or electromechanical braking device may be controlled. A plurality of control devices may optionally be present, one of which is associated with a hydraulic vehicle brake control device and another control device is associated with the electromechanical braking device.

The invention further relates to a brake system in a vehicle, wherein the brake system is equipped with a hydraulic vehicle brake and an electromechanical braking device having an electric brake motor, and in addition, at least one previously described control device for controlling the adjustable components of the brake system.

The invention also relates to a vehicle with a previously described braking system. The vehicle is, in particular, a motor-driven, at least dual-axis vehicle, for example a passenger vehicle or a semi-truck.

The invention further relates to a computer program product comprising a program code which is designed to execute the previously described method steps. The computer program product runs in the previously described control unit.

Further advantages and expedient embodiments can be found in the claims, description of the figure and the drawings. The figures show:

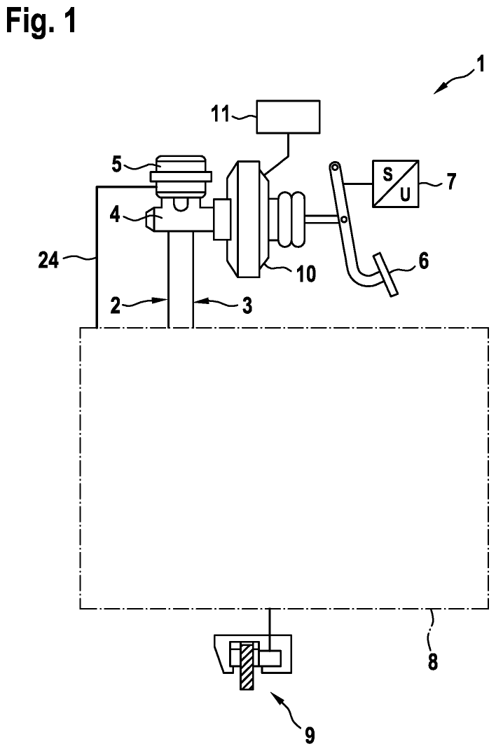

FIG. 1 a schematic illustration of a hydraulic vehicle brake with a braking force amplifier forming an actuator, wherein the wheel brake devices of the vehicle brake on the vehicle rear axle are additionally designed as electromechanical braking devices with an electric brake motor,

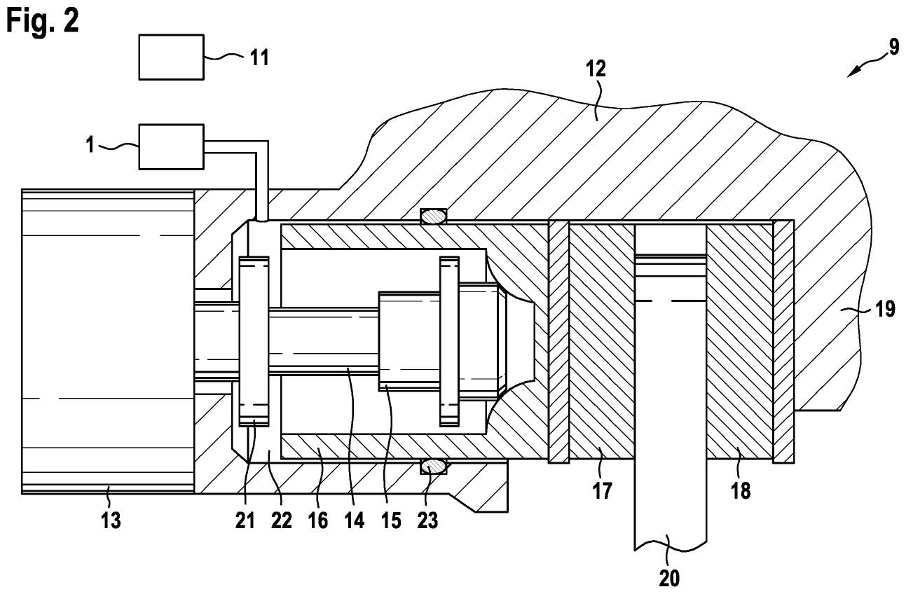

FIG. 2 a section through an electromechanical braking device with an electric braking motor,

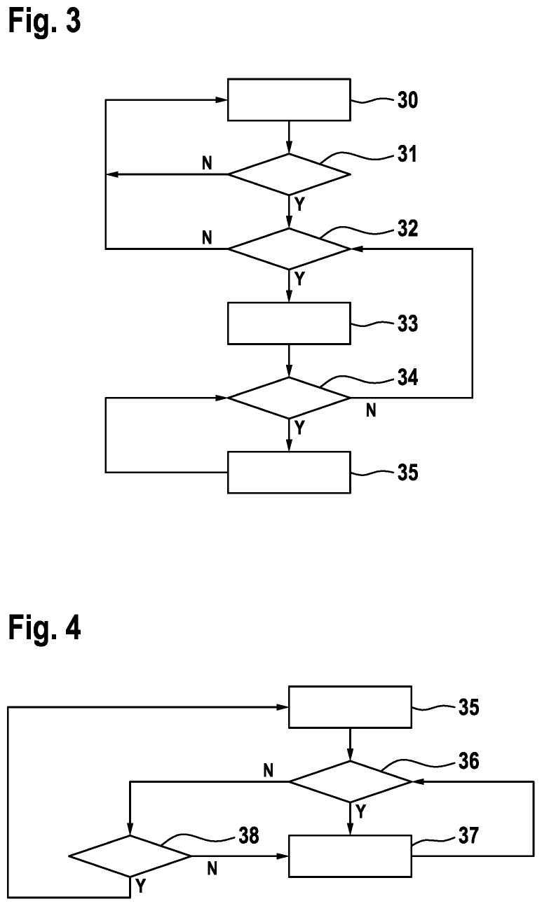

FIG. 3 a flowchart showing method stages for building up an additional electromechanical braking force in the event that a brake servo unit of the hydraulic vehicle brake has partially or completely failed,

FIG. 4 a flowchart as a continuation of FIG. 3 with a control loop for limiting electromechanical braking.

In the figures, identical elements are marked with identical reference numbers.

The brake system in a vehicle illustrated in FIG. 1 includes a hydraulic vehicle brake 1 having a front axle brake circuit 2 and a rear axle brake circuit 3 for supplying and controlling wheel brake devices 9 on each wheel of the vehicle with braking fluid under hydraulic pressure. In an alternative embodiment, it is also possible for the brake circuits to be formed diagonally. The two brake circuits 2, 3 are connected to a common master brake cylinder 4, which is supplied with brake fluid via a brake fluid reservoir 5. The master brake cylinder piston within the master brake cylinder 4 is actuated by the driver via the brake pedal 6, and the pedal travel distance carried out by the driver is measured via a pedal travel distance sensor 7. A braking force amplifier 10 is located between the brake pedal 6 and the master brake cylinder 4, for example, and comprises an electric motor, which preferably operates the master brake cylinder 4 via a gear (iBooster). The braking force amplifier 10 forms an electrically controllable actuator to affect brake pressure. The iBooster 10 forms a brake servo unit.

The actuation movement of the brake pedal 6 as measured by the pedal travel distance sensor 7 is transmitted as a sensor signal to a control unit 11, in which actuating signals for controlling the brake amplifier 10 are generated. Brake fluid is supplied to the wheel brake devices 9 in each brake circuit 2, 3 via different switching valves that are part of a brake hydraulic system 8. The brake hydraulics system 8 further includes a hydraulic pump that is part of an electronic stability program (ESP).

The braking force amplification may additionally or alternatively be performed using an electrically controllable actuator downstream of the master brake cylinder 4 of the vehicle brake 1.

The vehicle brake 1 is provided with an additional hydraulic supply line 24 connecting the brake fluid reservoir 5 to the output valves of wheel brake devices 9.

In FIG. 2, the wheel braking device 9, which is arranged on a wheel on the rear axle of the vehicle, is shown in detail. The wheel braking device 9 is part of the hydraulic vehicle brake 1 and is supplied with brake fluid 22 from the rear axle brake circuit. The wheel braking device 9 also comprises an electromechanical braking device, which, like the hydraulic vehicle brake 1, is part of the brake system in the vehicle and is preferably used to keep the vehicle stopped when at rest, but it can also be used to slow down movement of the vehicle.

The electromechanical braking device includes a brake caliper 12 with a pincer 19 that engage a brake disc 20. As an actuator, the braking device comprises a DC electric motor as a brake motor 13, the rotor shaft of which rotates a spindle 14 on which a spindle nut 15 is supported. With rotation of the spindle 14, the spindle nut 15 is moved in an axial direction. The spindle nut 15 moves within a brake piston 16, the carrier of a brake pad 17, which is pressed against the brake disc 20 by the brake piston 16. On the opposite side of the brake disc 20 is another brake pad 18 which is held fixed to the pincer 19. The brake piston 16 is sealed on its outer side by means of a surrounding sealing ring 23, in a flow-tight manner, against the receiving housing.

Within the brake piston 16, the spindle nut 15, upon a rotation movement of the spindle 14, can move axially forward toward the brake disc 20, or axially backward in an opposite rotational movement of the spindle 14 until a stop 21 is reached. To generate a clamping force, the spindle nut 15 is applied to the interior side of the brake piston 16, thereby pushing the brake piston 16, which moves axially in the braking device, along with the brake pad 17, against the side of the brake disc 20 facing it.

For the hydraulic braking force, the hydraulic pressure of the brake fluid 22 from the hydraulic vehicle brake 1 acts on the brake piston 16. The hydraulic pressure can also be supportive when the vehicle is stopped when the electromechanical braking device is actuated, so that the total braking force consists of the electromotively actuated portion and the hydraulic portion. While the vehicle is traveling, either only the hydraulic vehicle brake is active, or both the hydraulic vehicle brake and the electromechanical braking device, or only the electromechanical braking device, in order to generate braking power. The control signals for controlling the adjustable components of the hydraulic vehicle brake 1 and the electromechanical wheel braking device 9 are generated in the control unit 11.

FIG. 3 illustrates a flowchart with method steps for establishing an additional electromechanical braking force in the event that a brake servo unit of a hydraulic vehicle brake has failed. FIG. 3 thus relates to a braking case with actuation of the hydraulic vehicle brake, but with a complete failure or at least a partial failure of a brake servo unit such as iBooster 10 or a plunger. In this case, the braking force initiated by the driver via the actuation of the brake pedal is not or is only insufficiently amplified, so that the driver must push the brake pedal significantly more forcefully compared to the intact hydraulic vehicle brake in order to achieve equally high deceleration values.

In the initial situation according to method step 30, the aforementioned partial failure or complete failure of a brake servo unit in the hydraulic vehicle brake is assumed. In the following method step 31, a query is carried out as to whether the hydraulic vehicle brake is actuated, in particular via actuation of the brake pedal. If this is not the case, following the no branch (“N”), one returns to the first method step 30, and it is checked again at cyclic intervals whether the brake pedal is actuated. If, on the other hand, the query in step 31 results in information that the driver is actually actuating the brake pedal, the yes branch (“Y”) is followed to the next method step 32.

In method step 31, as an alternative to brake pedal operation, it can also be requested whether a braking force requirement is otherwise requested, in particular via a driver assistance system that operates automatically.

In method step 32, the query is made as to whether the hydraulic brake pressure exceeds a first, lower threshold value. If this is not the case, the system returns to the beginning of the method in method by following the no branch. However, if the current hydraulic brake pressure exceeds the lower threshold value, a minimum requirement must be assumed that triggers the subsequent actions.

In this case, by following the yes branch, the next method step 33 is reached, in which the clearance distance is reduced by actuating the electromechanical braking device until the brake pads are applied to a brake disc.

The reduction of the clearance distance can optionally also be carried out below the lower limit value, which represents a minimum pressure. This has the advantage that as the braking request increases, dead times are reduced when the electromechanical braking is activated.

Following the pre-positioning of the electromechanical braking device in method step 33, in the next method step 34, another query is made as to whether a second brake pressure limit is exceeded that is higher than the first lower brake pressure limit according to method step 32. Unless this is the case, the system returns to method step 32 by following the no branch. However, if the current brake pressure exceeds the limit value according to method step 34, the yes branching is followed to the next step 35, in which the electromechanical braking device is actuated by controlling the electric brake motor 13 and an electromechanical braking force is generated in addition to the hydraulic braking force. As a result, the partial failure or total failure of the brake servo unit in the hydraulic vehicle brake may be compensated.

FIG. 4 shows activation of the electromechanical braking device in method step 35 with a control loop for limiting the maximum electromechanical braking force generated. After activating the electromechanical braking force in step 35, in the next step 36, the query is made as to whether the wheel slippage on the relevant vehicle wheel on which the electromechanical braking force is generated exceeds a threshold value. If so, by following the yes branch, the system advances to step 37, according to which the electromechanical braking force is automatically reduced in the electromechanical braking device. Then, it returns to step 36 and checks again at cyclic intervals whether the wheel slippage on the relevant wheel is exceeded.

If, on the other hand, the query in step 36 determines that the wheel slippage is still below the threshold value, then the no branch is followed to step 38, in which it is requested whether the current braking request, i.e. the braking force requested by the driver, is greater than that provided by the electromechanical braking device, taking into account the hydraulic braking force. If this is the case, the yes branch is followed to return to step 35 and the electromechanical braking device is adjusted accordingly to implement the braking request. Conversely, if the braking request is below the current electromechanical braking force, then by following the no branch, step 37 is reached for reducing the electromechanical braking force. However, a return to method step 35 is also possible.

While building up electromechanical braking force as described in FIG. 3 and FIG. 4, the increase occurs in several stages, wherein during each stage the electromechanical braking force is kept constant or at least approximately constant. The minimum duration for switching to a higher or lower stage is, for example, 50 ms. A plurality of stages may be provided, for example three, four, five or even more stages, wherein the electromechanical braking force is increased step-by-step. Also, the reduction of the electromechanical braking force may be performed in stages.

1. A method for actuating a brake system in a vehicle, wherein the brake system includes a hydraulic vehicle brake including a brake servo unit and at least one electromechanical braking device having an electric braking motor configured to generate an electromechanical braking force, the method comprising:
in an event of a partial failure or a complete failure of the brake servo unit of the hydraulic vehicle brake, actuating the electromechanical braking device when braking, in addition to the hydraulic braking force, such that an increase in electromechanical braking force is performed in multiple stages,
wherein, at each stage of the multiple stages, the electromechanical braking force is held constant or approximately constant.

2. The method according to claim 1, wherein the brake servo unit is electrically actuatable in the hydraulic vehicle brake.

3. The method according to claim 1, wherein:
a maximum electromechanical braking support is established, and
each stage of the multiple stages corresponds to a defined percentage of a maximum electromechanical braking support.

4. The method according to claim 1, wherein the multiple stages includes at least three stages.

5. The method according to claim 3, wherein to change the electromechanical braking force, the electromechanical braking motor is actuated for a duration of at least 20 ms in order to increase or decrease the defined percentage of the electromechanical braking force by one stage.

6. The method according to claim 5, wherein the duration depends on a state or operational parameters of the vehicle including an electrical voltage in an on-board power system or on a motor speed of a brake motor.

7. The method according to claim 3, wherein the maximum electromechanical braking support is set to a value less than a maximum possible mechanical braking force.

8. The method according to claim 3, wherein:
the electromechanical braking force is dependent on a height of a brake pedal actuation, and
upon reaching a brake pedal actuation limit, the electromechanical braking force is limited to the maximum electromechanical braking support.

9. The method according to claim 1, wherein the electromechanical braking force is only generated when a hydraulic brake pressure in the hydraulic vehicle brake reaches or exceeds a minimum pressure level.

10. The method according to claim 9, wherein when the hydraulic brake pressure is below the minimum pressure level, the electric brake motor is actuated to reduce a clearance distance until brake pads are applied to a brake disc.

11. The method according to claim 1, wherein during slippage on a wheel of the vehicle, the electromechanical braking force acting on the wheel is reduced.

12. The method according to claim 1, wherein, when a braking operation is ended or the hydraulic braking force is reduced, the electromechanical braking force is reduced in several stages.

13. A control unit comprising a controller configured to control adjustable components of a hydraulic vehicle brake and/or an electromechanical braking device, the controller configured to perform the method according to claim 1.

14. A braking system in a vehicle comprising:
a hydraulic vehicle brake; and
an electromechanical braking device with an electric brake motor; and
a control unit according to claim 13 configured to control adjustable components of the braking system.

15. A vehicle having a braking system according to claim 14.

16. A non-transitory computer-readable memory product comprising a computer program product comprising program code configured to execute the method according to claim 1 when the computer program product is carried out in a computer.
